(19) United States
(12) Patent Application Publication
(10) Pub. No.: US 2006/0047878 A1
(43) Pub. Date: Mar. 2, 2006

(54) GPE register block

(76) Inventors: Daniel V. Zilavy, Fort Collins, CO (US); David R. Maciorowski, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 10/926,204

(22) Filed: Aug. 25, 2004

(51) Int. Cl. G06F 13/24

(52) U.S. Cl. 710/266

(57) ABSTRACT

Systems, methodologies, media, and other embodiments associated with general purpose event register blocks are described. One example system embodiment can include a general purpose event (GPE) register logic that can be configurable to provide multiple system control interrupt (SCI) output signals and be configurable to map selected event signals to selected SCI output signals where the multiple SCI output signals can be routed to multiple partitioned computer systems.

### BACKGROUND

ACPI (Advanced Configuration and Power Interface) is an open industry specification that defines a flexible and extensible interface for computer power management and related control operations. In general, the interface enables and supports power management through improved hardware and operating system coordination. ACPI allows the operating system to control the power states of many ACPI-supported hardware components, and/or to pass information to and from some hardware components.

The ACPI Specification describes how General Purpose Events (GPEs) can be used to inform the operating system that some event occurred, such as a laptop lid being closed or a thermal alert. For example, a hardware device can issue a notification to a hardware register, which in turn triggers a GPE event. The hardware register is represented to the operating system by an object commonly called a “GPE block.” A GPE block can be a logical construct that represents a set of GPE pins on the hardware register. The hardware signals that are connected to those pins are arbitrary in nature (within some guidelines outlined by the ACPI specification). The operating system sees the GPE block as containing two register sets: an enable register to control whether or not a particular pin is enabled, and a status register to determine if a particular pin is asserted. If the operating system detects that a pin is both enabled and asserted, then it runs an ACPI control method associated with the pin to handle the event. For example, a system control interrupt (SCI) signal can be generated that informs the operating system that a pin is enabled and asserted.

The current ACPI specification can describe up to two GPE register blocks in the Fixed ACPI Description Table (FADT) and an arbitrary amount of additional GPE blocks in the ACPI namespace. The GPE events are typically hardware events that require operating system attention, including but not limited to, Host Bus Adapter (HBA) slot doorbells, thermalerts, and chassis intrusion.

FIG. 1 illustrates a prior art GPE register block 100 that includes a status register 105 and an enable register 110. In the example, four event signals 0-3 are shown where each event signal is latched into the status register 105, which in turn is gated by a corresponding enable bit from the enable register 110. For example, a signal corresponding to event 0 can set a status bit in the status register 105 at GPE0_STS0. The event 0 also has a corresponding enable bit at GPE0_EN0 within the enable register 110. If both the status bit and enable bit are on (e.g. “1”), a system control interrupt (SCI) signal is generated. The SCI signal can then be transmitted to the operating system, for example, through a system interrupt controller. When the operating system detects the SCI signal, a corresponding ACPI control method can be initiated to handle the event. The other events 1-3 are similarly configured and the output signals from the status register 105 and enable register 110 are OR'd together to create the SCI signal. Thus, the occurrence of any one of the events 0-3 may trigger the SCI signal.

In partitionable computer systems, the system can be partitioned into multiple distinct computer systems, each running its own operating system. In a partitioned system, events may be associated with different partitions. In order for an event to be properly handled by its responsible partition, the event needs to be detected by the responsible partition, for example, by detecting an SCI signal. For example, an event corresponding to an HBA slot doorbell being pressed should be detected by the partition that controls the HBA in that slot. In prior systems, SCI signals from the GPE blocks were routed to a single partition. The operating system of the partition had to be modified to recognize events for other partitions and forward the associated SCI signals to the appropriate partition. Modifying an operating system to handle a custom configuration can be difficult, time consuming, and can introduce errors.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example prior art GPE register block.

FIG. 2 illustrates an example GPE register block logic that is configurable.

FIG. 3 illustrates an example system of a partitioned computer system having a reconfigurable register block logic.

FIG. 4 illustrates another example GPE register block that associates GPE events with multiple system control interrupts.

FIG. 5 illustrates an example methodology that can be associated with designing a GPE register block.

FIG. 6 illustrates an example methodology that can be associated with reconfiguring a GPE register block.

FIG. 7 illustrates an example computing environment in which example systems and methods illustrated herein can operate.

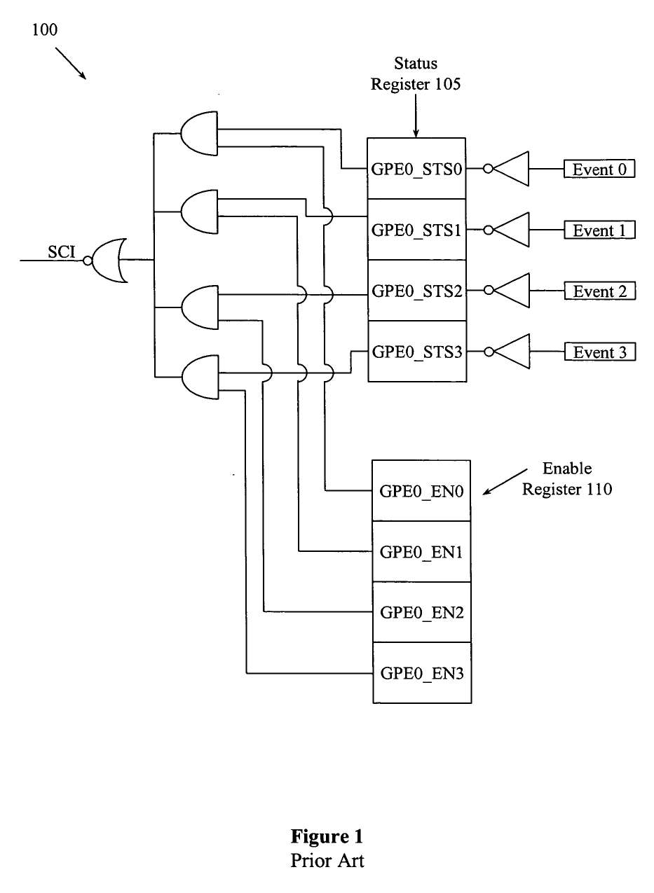

### DETAILED DESCRIPTION

Example systems, methods, media and other embodiments are described herein that are associated with general purpose event (GPE) register blocks. In one example system, a reconfigurable general purpose event register block logic can be configured to provide distinct GPE register blocks with separate system control interrupt (SCI) signal outputs. GPE events can be associated with selected SCI signals that can then be routed to a computer system partition which is to handle the resource causing the event. In one example, operating systems running on separate partitions do not need to be modified in order to handle general purpose events for other operating systems since system control interrupts for events can be selectively mapped and directly routed to a designated partition. In another example, the GPE register block logic can be reconfigured to provide different mappings of events to SCI signals and/or to provide new routings of SCI signals to selected operating systems.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmable logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, directing, configuring, designing, selecting, causing, displaying, or the like, refer to actions and processes of a computer system, logic, processor, or similar electronic device that manipulates and transforms data represented as physical (electronic) quantities.

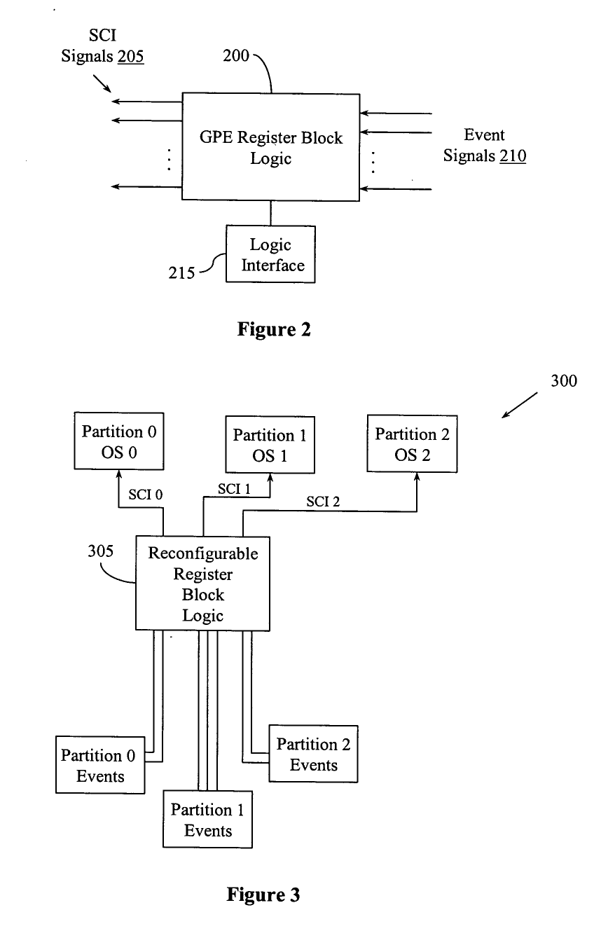

FIG. 2 illustrates an example general purpose event (GPE) register block logic 200 that is configurable to provide multiple system control interrupt (SCI) output signals 205 that can be associated with one or more event signals 210. For example, the GPE register block logic 200 can be configurable to map selected event signals from the event signals 210 to selected SCI output signals 205 where the multiple SCI output signals 205 can be routed to multiple partitioned computer systems. Based on the ACPI specification, a system control interrupt (SCI) signal 205 can be used by hardware to notify an operating system when general purpose events occur. As previously described, general purpose events include hardware events whose state is set by one of the event signals 210.

In a partitioned computer system, multiple partitions can be defined where each partition runs its own operating system. Furthermore, different operating systems may be responsible for handling various general purpose events. As part of the partitioned system, the GPE register block logic 200 can be configured to route selected SCI signals 205 to the appropriate operating system. In this manner, each operating system can directly receive system control interrupts triggered by selected general purpose event signals 210 that the operating system is responsible for handling, rather than having the SCI signal be processed through an intermediate operating system.

It will be appreciated that the SCI signals 205 can be transmitted to a selected operating system through an operable connection using intermediate components, as described by the ACPI specification, before reaching the operating system. For example, the SCI signals 205 can be connected to a system interrupt controller that routes interrupts from the GPE register block logic 200 to a processor's local advanced programmable interrupt controller (APIC). The system interrupt controller can be an I/O streamlined advanced programmable interrupt controller (SAPIC).

In one example the GPE register block logic 200 may include a programmable logic device like a field programmable gate array (FPGA) or other programmable device. Using an FPGA, the GPE register block logic 200 can be configurable to allow a user to map and remap selected event signals 210 to selected SCI signals 205. For example, the FPGA can be configured to define distinct register blocks that provide separate SCI signals. The separate SCI signals can then be routed or otherwise transmitted to a selected operating system.

The FPGA, or other selected programmable logic device, can also be reconfigured after a previous register block configuration. In this manner, when a partitioned computer system is reconfigured to define it's partitions differently, the GPE register block logic can also be reconfigured to remap the event signals 210 to the SCI signals 205, which can then be routed to the appropriate partition.

Optionally, a logic interface 215 can be provided that is configured to allow a user to configure and reconfigure the GPE register block logic 200. The interface logic 215 can be and/or provide a graphical user interface for configuring the programmable logic device of the GPE register block logic 200. Depending on the selected programmable device, the logic interface 215 can be provided to allow user selections to define the register block logic 200 and to make associations between the event signals 210 and the SCI signals 205. The associations can be used, for example, to define a hardware description language (HDL) using appropriate software that corresponds to the selected programmable logic device. The register block logic 200 can then be configured in accordance with the associations made by the user. The programming of an FPGA or other programmable logic device is known in the art and will not be described in further detail.

In another example, the GPE register block logic 205 can include an application specific integrated circuit (ASIC) that is configured to provide separate SCI signals 205. The ASIC can also be configured with selected associations between the event signals 210 and the SCI signals 205.

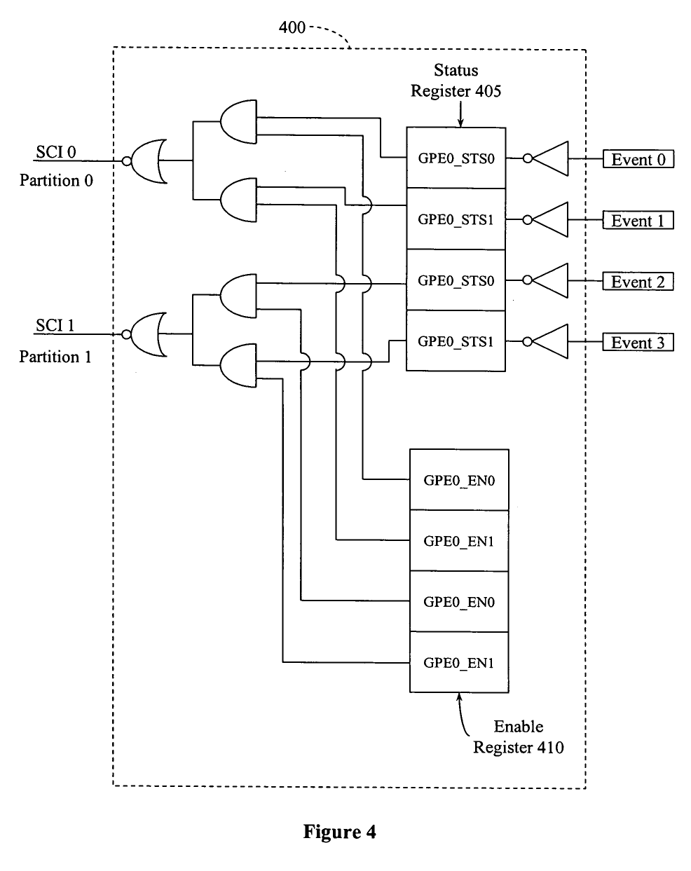

Illustrated in FIG. 3 is an example system 300 of a partitioned computer system that includes an example reconfigurable register block logic 305. In the example system 300, three partitioned computer systems 0-2 are illustrated each having their own operating system OS 0, OS 1, and OS 2, respectively. Of course, fewer or greater numbers of partitions can be used. The register block logic 305 can be configured to provide multiple and separate system control interrupt signals (e.g. SCI 0, SCI 1, and SCI 2) that can be routed/directed to a selected partition. The register block logic 305 can further be configured to map selected general purpose event (GPE) signals to selected system control interrupt (SCI) signals. As previously described with reference to FIG. 2, the register block logic 305 can be a device that is reconfigurable that allows re-mapping and/or re-routing of the GPE signals and SCI signals.

In one example, if one or more general purpose events are to be handled by the operating system OS 0 of partition 0, those events need to be detected by the OS 0. The detecting can be performed by detecting one or more SCI signals that are directed to partition 0. For example, one or more partition 0 events are shown that can be selectively combined within the register block logic 205 to generate one or more system control interrupt signals (e.g. SCI 0). The SCI 0 signal can then be routed to the operating system 0. Similarly, events associated with partition 1 and 2 can be combined within the register block logic 305 to create one or more system control interrupt signals (e.g. SCI 1 and SCI 2, respectively) that are directed to the appropriate operating system. A system interrupt controller (not shown) can be used transfer the SCI signals to an operating system.

In this manner, a partition, and its operating system, can directly receive system control interrupts (SCIs) from general purpose events that the partition is to handle. For example, if partition 0 is to control a host bus adapter slot doorbell, then when the doorbell is activated, the corresponding system control interrupt (e.g. SCI 0) can be directed to partition 0 by configuring the register block logic 305 appropriately. If the partitions should change, for example by reconfiguring the partitions, removing partitions, adding partitions, and the like, the register block logic 305 can also be reconfigured to define new GPE register blocks, remap selected events and/or system control interrupt signals. As previously described, the register block logic 305 can be implemented using a field programmable gate array (FPGA) or other programmable logic, that can be reprogrammed to define and/or reroute selected SCI signals to appropriate partitions.

In another example, the system 300 can include a logic interface (not shown) that is configured to allow a user to configure the register block logic 305, and to make associations between the GPE signals and the SCI signals. The logic interface can be similarly implemented as described with the logic interface 215 of FIG. 2.

As previously described, the partition events 0-2 are associated with GPE signals that relate to hardware events configured to cause an action by an operating system that is responsible for handling the event. For example, an ACPI control method can be executed in response to a system control interrupt. The hardware events can include, for example, one or more of: a host bus adapter slot doorbell, a thermalert, a chassis intrusion, or other defined hardware event.

In one example, the register block logic 305 can be configured in accordance with the ACPI specification. With reference to FIG. 4, an example register block configuration 400 is shown that can be configured with the register block logic 305 of FIG. 3. The register block 400 can be configured to define a status register 405 and an enable register 410 for general purpose event signals. The example configuration defines two distinct register blocks that each provide a system control interrupt (SCI) signal (e.g. SCI 0 and SCI 1). The SCI signals can then be routed to a selected partition.

In the example configuration, GPE event signals 0 and 1 are configured to generate the signal SCI 0, and GPE event signals 2 and 3 are configured to generate the signal SCI 1. As shown, partition 0 will be responsible for handling events 0 and 1, while partition 1 will handle events 2 and 3. The events 0-3 are latched into the status register 405, which is defined into separate register blocks. Based on the ACPI specification, the status register 405 enumerates its entries using the format GPE0_STSx where “x” starts at value “0” then “1” and so on. This is represented in FIG. 4 by GPE0_STS0 and GPE0_STS1, which are associated to system control interrupt signal SCI 0. Similarly, the enable register defines its entries with the format GPE0_ENx. The separate system control interrupt signal SCI 1 has its associated entries from the status register 405 and the enable register 410 defined beginning with the “x” value of “0” rather than continuing the sequence from the previous entries. This is one example for defining distinct register blocks with the register block 400.

With further reference to FIG. 4, the example configurations shows general purpose event signals from event 0 and 1 being latched into the status register 405 into locations GPE0_STS0 and GPE0_STS1, respectively. Each event includes a corresponding enable bit from the enable register 410. The status bit and the enable bit are combined with an “AND” gate. The output signals from the “AND” gates are OR'd together to generate the SCI 0 signal that is routed to partition 0. Thus, the occurrence of either event 0 or 1 may trigger a system control interrupt that is represented by SCI 0. The partition 0 can then take an appropriate action in response to the event occurrence. Events 2 and 3 are similarly configured to generate a corresponding SCI 1 signal that is directed to partition 1.

Using a programmable logic device, the register block logic 400 can be programmatically defined to associate the events to selected SCI signals. Of course, many different combinations of signal input and outputs can be programmed using a programmable logic device other than the configuration illustrated. Furthermore a programmable logic device such as an FPGA allows the register block logic 400 to be reconfigured so that different associations between GPE events and system control interrupt signals can be created. Different amounts of SCI signals can also be provided. With the example register block logics 200 or 305, greater flexibility can be provided in designing and/or reconfiguring partitioned computer systems.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that various actions could occur concurrently, substantially in parallel, and/or at substantially different points in time.

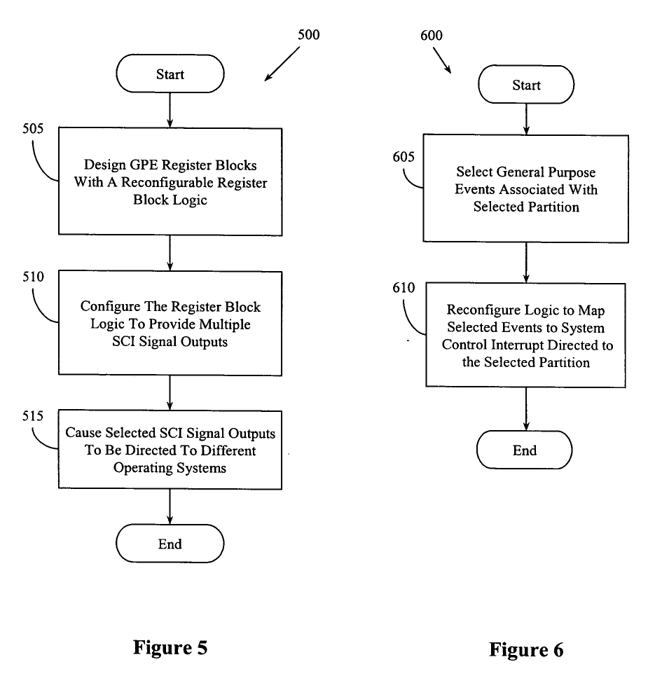

Illustrated in FIG. 5 is an example methodology 500 that can be associated with designing/configuring a GPE register block logic. The illustrated elements denote “processing blocks” that may be implemented in logic. In one example, the processing blocks may represent executable instructions that cause a computer, processor, and/or logic device to respond, to perform an action(s), to change states, and/or to make decisions. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), a programmable logic device, or other logic device. The diagram of FIG. 5, as well as the other illustrated diagrams, are not intended to limit the implementation of the described examples. Rather, the diagrams illustrate functional information one skilled in the art could use to design/fabricate circuits, generate software, or use a combination of hardware and software to perform the illustrated processing. The foregoing applies to all methodologies and examples described herein.

With reference to FIG. 5, the example methodology 500 can be associated with a system having general purpose event (GPE) register blocks in accordance with the ACPI specification where event signals inputted to the GPE register blocks can generate a system control interrupt (SCI) signal that is outputted to an operating system. The method can comprise designing the GPE register blocks with a register block logic that is reconfigurable (Block 505). The register block logic can be configured to provide multiple SCI signal outputs where selected event signals are mapped to a selected SCI signal output (Block 510). For example, the configuring of block 510 can include programmatically configuring and/or reconfiguring the register block logic using an executable program. Selected SCI signal outputs can then be caused to be directed to different operating systems associated with different partitioned computer systems (Block 515).

In one example, the designing block 505 can include replacing an existing GPE register blocks with the register block logic that is reconfigurable. This may be involved in a system that is previously designed with a non-configurable GPE register block which can then be redesigned using a configurable logic such as an FPGA as described in previous examples. In another example, the register block logic can be initially designed by implementing a programmable logic device such as an FPGA, a complex programmable logic device (CPLD), other programmable logic device that allows the register blocks to be reconfigurable. In this manner, if the partitions of the system are reconfigured, GPE events can also be reconfigured to appropriate system control interrupts that can be routed to the corresponding partition. Of course, the reconfigurable register block logic can be implemented with other systems and have other uses in addition to a partitioned computer system.

In another example, the configuring block 510 can include providing a user interface that is configured to allow a user to graphically associate selected event signals with the selected SCI signal outputs. The user interface can be, for example, software like an executable program that provides displayed options to a user and allows the user to input designated selections and associations for configuring the register block logic. The software can also include tools that cause the programmable logic device to be programmed or otherwise reconfigured in accordance with the user's selections. It will be appreciated that such software tools are readily available and may be provided with a selected programmable logic device. It will be further appreciated that the methodology 500 can be implemented as a graphical user interface including processor executable instructions that are provided by a computer-readable medium and performs the methodology 500.

Illustrated in FIG. 6 is an example methodology 600 that can be associated with reconfiguring general purpose events and system control interrupt signals. For example, suppose a GPE register block logic as previously described, has been configured to associate selected GPE events with selected system control interrupts. A user may then wish to reconfigure those associations. For example, in a partitioned computer system, if the partitions are changed, the system control interrupts may also need to be reconfigured to correspond to the appropriate partition.

With reference to FIG. 6, the methodology 600 may include selecting general purpose events associated with a selected partition (block 605). The register logic can then be reconfigured to map selected events to a system control interrupt (block 610). For example, using a GPE register block logic as previously described that is implemented with a field programmable gate array, it can be reconfigured to define new register blocks and associate signal inputs (e.g., GPE events) to selected signal outputs (SCI signals). In one example, the reconfiguring block 610 can include defining distinct register blocks that provide separate SCI signals. Blocks 605 and/or 610 can be repeated for additional partitions to associate events and system control interrupts. It will be appreciated that the methodology 600 can be implemented as a graphical user interface including processor executable instructions that are provided by a computer-readable medium and performs the methodology 600.

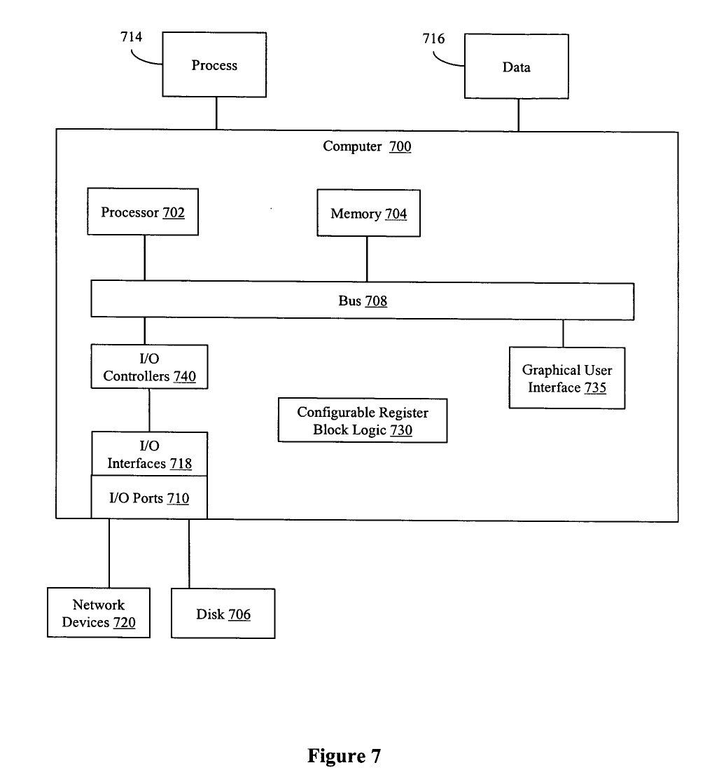

FIG. 7 illustrates an example computing device in which example systems and methods described herein, and equivalents, can operate. The example computing device may be a computer 700 that includes a processor 702, a memory 704, and input/output ports 710 operably connected by a bus 708. In one example, the computer 700 may include a configurable register block logic 730 to facilitate implementing a configurable/reconfigurable GPE register block. The register block logic 730 can be implemented similar to the register block logic 200, 305 described in FIGS. 2 and 3, respectively, and/or the other systems and methods described herein. The register block logic 730 is shown logically within the computer 700 but it will be appreciated that the logic 730 can be implemented to communicate with an operating system based on the ACPI specification. The computer 700 can provide a graphical user interface 735 that can be configured based on the interface logic 215 of FIG. 2, and/or based on the example methods of FIGS. 5 and 6.

Generally describing an example configuration of the computer 700, the processor 702 can be a variety of various processors including dual microprocessor and other multi-processor architectures. The memory 704 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 706 may be operably connected to the computer 700 via, for example, an input/output interface (e.g., card, device) 718 and an input/output port 710. The disk 706 can include, but is not limited to, devices like a magnetic disk drive, a solid state disk drive, a floppy disk drive, a tape drive, a Zip drive, a flash memory card, and/or a memory stick. Furthermore, the disk 706 can include optical drives like a CD-ROM, a CD recordable drive (CD-R drive), a CD rewriteable drive (CD-RW drive), and/or a digital video ROM drive (DVD ROM). The memory 704 can store processes 714 and/or data 716, for example. The disk 706 and/or memory 704 can store an operating system that controls and allocates resources of the computer 700.

The bus 708 can be a single internal bus interconnect architecture and/or other bus or mesh architectures. While a single bus is illustrated, it is to be appreciated that computer 700 may communicate with various devices, logics, and peripherals using other busses that are not illustrated (e.g., PCIE, SATA, Infiniband, 1394, USB, Ethernet). The bus 708 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 700 may interact with input/output devices via i/o interfaces 718 and input/output ports 710. Input/output devices can include, but are not limited to, a keyboard, a microphone, a pointing and selection device, cameras, video cards, displays, disk 706, network devices 720, and the like. The input/output ports 710 can include but are not limited to, serial ports, parallel ports, and USB ports.

The computer 700 can operate in a network environment and thus may be connected to network devices 720 via the i/o devices 718, and/or the i/o ports 710. Through the network devices 720, the computer 700 may interact with a network. Through the network, the computer 700 may be logically connected to remote computers. The networks with which the computer 700 may interact include, but are not limited to, a local area network (LAN), a wide area network (WAN), and other networks. The network devices 720 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 720 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A system, comprising:
a general purpose event (GPE) register logic being configurable to provide multiple system control interrupt (SCI) output signals and, configurable to map selected event signals to selected SCI output signals where the multiple SCI output signals can be routed to multiple partitioned computer systems.

2. The system of claim 1, where the GPE register logic is configurable to define a register block for one or more event signals, the register block being configured to include a status register and an enable register.

3. The system of claim 2, where the register block is configured in accordance with Advanced Configuration and Power Interface (ACPI) specification.

4. The system of claim 1, the GPE register logic includes a programmable logic device.

5. The system of claim 4, further including an interface logic configured to provide a graphical user interface for configuring the programmable logic device.

6. The system of claim 1, where the GPE register logic includes a field programmable gate array.

7. The system of claim 1, where the GPE register logic includes an application specific integrated circuit.

8. The system of claim 1, where the GPE register logic can be reconfigured to provide different mappings of the selected event signals to the selected SCI output signals.

9. The system of claim 1 where the GPE register logic includes a means for providing one or more GPE register blocks.

10. A system, comprising:
at least a first partitioned computer system and a second partitioned computer system where the first partitioned computer system includes a first operating system and the second partitioned computer system includes a second operating system;
a register block logic that is reconfigurable to map selected general purpose event (GPE) signals to selected system control interrupt (SCI) signals; and
where one or more of the SCI signals are directed to the first operating system and one or more of the SCI signals are directed to the second operating system.

11. The system of claim 10 where the register block logic includes a field programmable gate array.

12. The system of claim 10 where the register block logic is configurable to define a status register and an enable register for each of the GPE signals.

13. The system of claim 12 where the status register and the enable register include output signals that are combined to form an SCI signal.

14. The system of claim 10 further including a logic interface configured to allow a user to make associations between the GPE signals and the SCI signals, and is configured to cause the register block logic to be reconfigured in accordance with the associations.

15. The system of claim 10 where the GPE signals are associated with hardware events configured to cause an action by the first or second operating system.

16. The system of claim 15 where the hardware events include one or more of: host bus adapter slot doorbells, thermalerts, and chassis intrusion.

17. The system of claim 10 where the register block logic includes a means for providing a reconfigurable general purpose event register block.

18. A computer-readable medium providing processor executable instructions operable to perform a method for a system having general purpose event (GPE) signals in accordance with the Advanced Configuration and Power Interface (ACPI) specification where the GPE signals can trigger a system control interrupt (SCI) signal that is outputted to an operating system, the method comprising:
designing GPE register blocks with a register block logic that is reconfigurable;
configuring the register block logic to provide multiple SCI signal outputs where selected GPE signals are mapped to a selected SCI signal output; and
causing selected SCI signal outputs to be directed to different operating systems associated with different partitioned computer systems.

19. The computer-readable medium of claim 18, where the designing includes replacing the GPE register blocks with the register block logic.

20. The computer-readable medium of claim 18, where the configuring includes providing a user interface configured to allow a user to graphically associate selected event signals with the selected SCI signal outputs.

21. The computer-readable medium of claim 18, where the designing includes implementing the register block logic using a programmable logic device.

22. The computer-readable medium of claim 18, where the computer-readable medium includes providing an executable program configured to perform the method.

23. A method for configuring a general purpose event (GPE) register block that is configured with a first mapping of GPE signals to selected system control interrupt (SCI) signals where the SCI signals are directed to selected computer partitions, the method comprising:
selecting GPE signals that are to be associated with a selected computer partition; and
reconfiguring a logic, that implements the GPE register block, to create a second mapping of the selected GPE signals to SCI signals directed to the selected computer partition.

24. The method of claim 23 further including repeating the selecting for additional computer partitions.

25. The method of claim 23, the reconfiguring including defining distinct register blocks that provide separate SCI signals.

26. A system, comprising:
means for providing multiple system control interrupt (SCI) signals in a general purpose event (GPE) register block where the means for providing is configurable; and
means for associating general purpose events to selected SCI signals where the selected SCI signals can be routed to separate operating systems.

27. The system of claim 26, the means for providing includes a programmable logic device.

28. The system of claim 26 where the means for providing is reconfigurable.
